(19) United States
(12) Patent Application Publication
(10) Pub. No.: US 2011/0018457 A1
(43) Pub. Date: Jan. 27, 2011

(54) AC LED device for eliminating harmonic current

(75) Inventors: Pei-Hsuan Lan, Banciao City (TW); Jen-Hua Yang, Luodong Township (TW)

Correspondence Address: BACON & THOMAS, PLLC, 625 SLATERS LANE, FOURTH FLOOR, ALEXANDRIA, VA, 22314-1176, US

(73) Assignee: Forward Electronics Co., Ltd., Taipei City (TW)

(21) Appl. No.: 12/588,327

(22) Filed: Oct. 13, 2009

(30) Foreign Application Priority Data
Jul. 27, 2009 (TW) 098213712

(51) Int. Cl. H05B 37/02

(52) U.S. Cl. 315/250

(57) ABSTRACT

An AC LED device for eliminating harmonic current comprises: a first AC-LED group, a second AC-LED group, and a resistor. The first AC LED group and the second AC LED group are connected in parallel to the resistor, and the resistor is further connected to an AC power supply terminal. Each of the first AC LED group and the second AC LED group has a forward on voltage such that the AC LED device has an overall forward on voltage that is lower than a voltage of the AC power supply terminal and also lower than a forward on voltage of the first AC LED group and the second AC-LED group connected in series. Therefore, harmonic current can be effectively eliminated in LED optical mask design, semiconductor manufacturing process or packaging process.

### BACKGROUND OF THE INVENTION

1. Field of the Invention

The invention relates generally to an AC LED device and, more particularly, to an AC LED device for eliminating harmonic current.

2. Description of Related Art

As the increasing popularity of LED, an AC LED has been developed for being directly connected to an AC power supply terminal, so as to allow LED to be powered by the utility power for illuminating.

FIG. 1 shows an AC LED, which includes four AC LED blocks connected in series to the AC power supply terminal. Each of the AC LED blocks has a forward on voltage and the AC LED has an overall forward on voltage. The AC LED is turned on only when the voltage of the AC power supply terminal is higher than the overall forward on voltage of the AC LED. For instance, each AC LED block has a forward on voltage of 24V, and the four AC LED blocks connected in series have an overall forward on voltage of 96V. Therefore, the AC LED is turned on to illuminate when the AC power voltage is higher than 96V. In general, the root mean square value of the voltage in the AC power supply terminal is 110V, and its peak value is the root mean square value multiplied by root of 2, i.e., 156V. The peak value of the AC power supply terminal is higher than the overall forward on voltage of the AC LED such that the four AC LED blocks connected in series can be turned on to illuminate. The comparison between voltages of the AC-LED and the AC power supply terminal is shown in FIG. 2.

However, the overall forward on voltage would be too high due to the series connection of AC LED blocks. According to the measurement of an AC LED application, high overall forward on voltage would lead to harmonic current. To solve this problem, in the prior art, the AC LED is connected to a converter for lowering down the over high voltage. However, the current AC LED typically does not have a converter owing to cost saving concern. Therefore, the solution to eliminate harmonic current is shifted into the LED optical mask design, semiconductor manufacturing process or packaging process.

### SUMMARY OF THE INVENTION

The object of the present invention is to provide an AC LED device for eliminating harmonic current, so as to eliminate harmonic current in LED optical mask design, semiconductor manufacturing process or packaging process.

To achieve this object, there is provided an AC LED device for eliminating harmonic current, which comprises: a first AC LED group; a second AC LED group; and a resistor including a first connection terminal and a second connection terminal. The first connection terminal is electrically connected to the first AC LED group and the second AC LED group. The second connection terminal is electrically connected to an AC power supply terminal. Each of the first AC LED group and the second AC LED group has an overall forward on voltage. The first AC LED group and the second AC LED group are connected in parallel to the first connection terminal of the resistor.

### BRIEF DESCRIPTION OF THE DRAWINGS

FIG. 1 schematically illustrates a conventional AC LED;

FIG. 2 shows the overall forward on voltage of a conventional AC LED in comparison with an AC power voltage;

FIG. 3 schematically illustrates an AC LED device in accordance with the present invention; and

FIG. 4 shows the overall forward on voltage of an AC LED device in comparison with an AC power voltage.

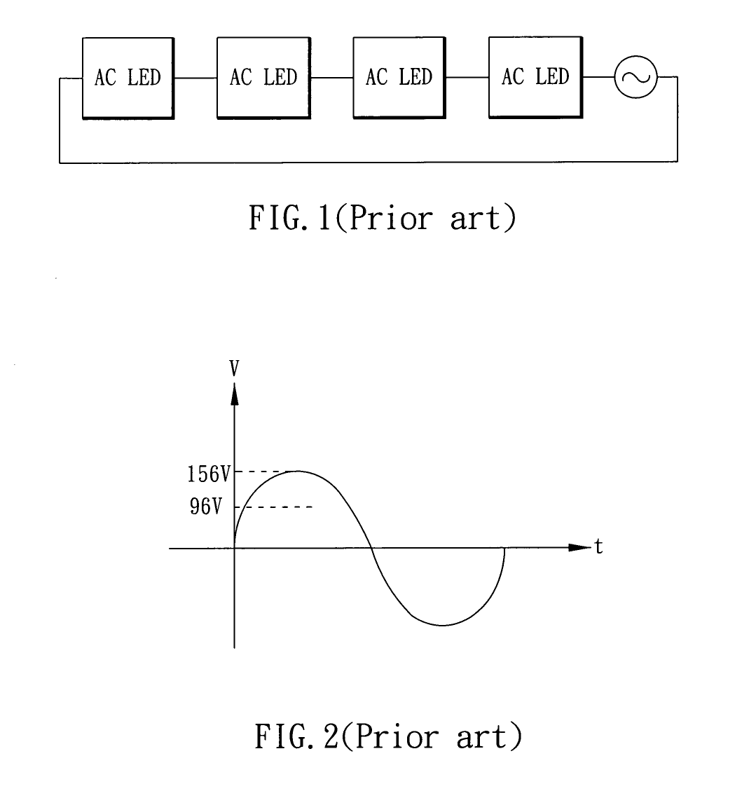

### DETAILED DESCRIPTION OF THE PREFERRED EMBODIMENT

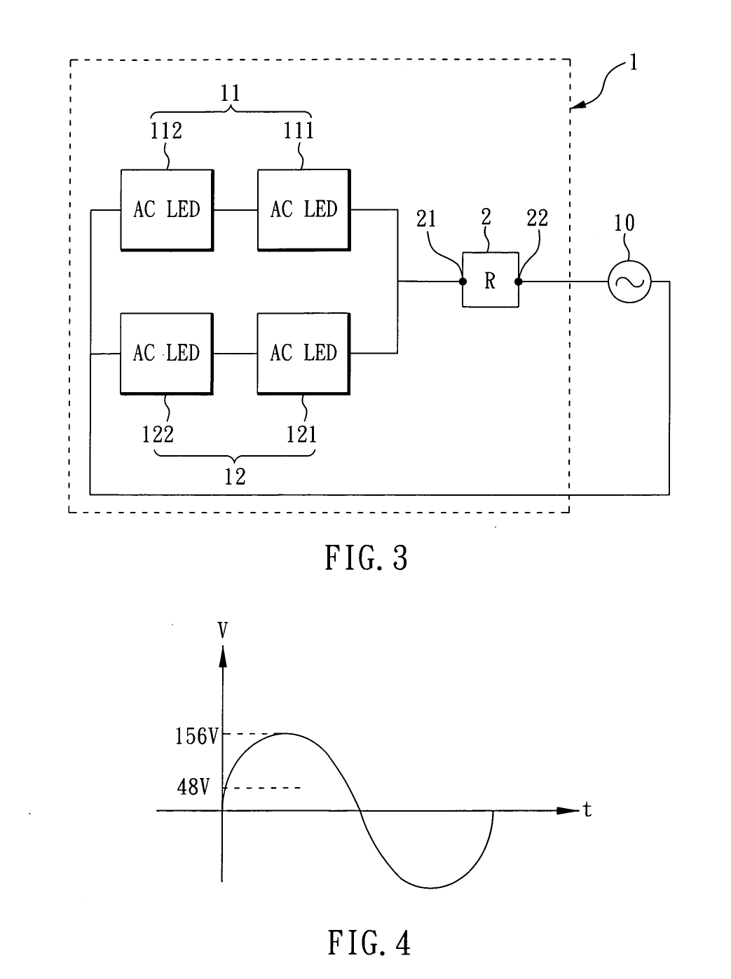

With reference to FIG. 3, there is shown an AC LED device 1 for eliminating harmonic current in accordance with the present invention. The AC LED device 1 comprises at least one AC-LED group and a resistor 2. In this embodiment, the at least one AC LED group includes a first AC LED group 11 and a second AC LED group 12 connected in parallel with each other. Each of the first AC LED group 11 and the second AC LED group 12 has a plurality of AC LED blocks 111-112,121-122 connected in series. Each of the AC LED blocks 111-112,121-122 is composed of a plurality of LED micro-chips, which are integrated in a chip.

In this embodiment, the first AC LED group 11 has a first AC LED block 111 and a second AC LED block 112, and the second AC LED group 12 has a third AC LED block 121 and a forth AC LED block 122. The resistor 2 has a first connection terminal 21 and a second connection terminal 22. The first connection terminal 21 is electrically connected to the first AC LED group 11 and the second AC LED group 12. The second connection terminal 22 is electrically connected to an AC power supply terminal 10. In the present invention, the AC-power supply terminal 10 is an utility power for providing a voltage to the AC-LED device 1.

Taking this embodiment as an example, each of the AC LED blocks 111-112,121-122 in FIG. 3 has a forward on voltage of 24V. As the AC LED blocks 111-112 connected in series are parallel to the AC LED blocks 121-122 connected in series, it only needs a voltage of 48V to turn on the AC LED blocks 111-112,121-122 for illuminating. Therefore, it could be done by configuring the resistance of the resistor 2 to make the voltage across the first AC LED group 11 and the second AC LED group 12 higher than 48V. For instance, the root mean square value of the voltage provided by the AC power supply terminal 10 is 110V, and its peak value is the root mean square value multiplied by root of 2, i.e., 156V.

In the present invention, the resistance of the resistor 2 is designed to be equal to that of the first AC LED group 11 and the second AC LED group 12, such that the voltage across the resistor 2 is equal to the voltage across the first AC LED group 11 and the second AC LED group 12. Therefore, the forward on voltage across the first AC LED group 11 and the second AC LED group 12 has a root mean square value of 55V and a peak value of 78V. The voltage across the resistor 2 also has a root mean square value of 55V and a peak value of 78V. Owing to that the root mean square value of 55V and the peak value of 78V are higher than the forward on voltage of 48V in the first AC LED group 11 and the second AC LED group 12, the first AC LED group 11 and the second AC LED group 12 are efficiently turned on for illuminating.

FIG. 4 shows the overall forward on voltage of the AC LED blocks 111-112,121-122 in comparison with the voltage of the AC power supply terminal 10. In prior art, the AC LED blocks 111-112,121-122 connected in series need an overall forward on voltage of 96V. In the present invention, the AC LED blocks 111, 112 connected in series are parallel to the AC LED blocks 121, 122 connected in series, such that it only needs a voltage of 48V to turn on the AC LED blocks 111-112,121-122 for illuminating. As the overall forward on voltage is considerably decreased, the harmonic current problem can be efficiently eliminated in the LED optical mask design, semiconductor manufacturing process or packaging process.

Although the present invention has been explained in relation to its preferred embodiment, it is to be understood that many other possible modifications and variations can be made without departing from the spirit and scope of the invention as hereinafter claimed.

What is claimed is:

1. An AC LED device for eliminating harmonic current, comprising:
a first AC LED group;
a second AC LED group; and
a resistor having a first connection terminal and a second connection terminal, the first connection terminal being electrically connected to the first AC-LED group and the second AC-LED group, the second connection terminal being electrically connected to an AC-power supply terminal,
wherein each of the first AC-LED group and the second AC-LED group has an overall forward on voltage, and the first AC-LED group and the second AC-LED group are connected in parallel to the first connection terminal of the resistor.

2. The AC LED device for eliminating harmonic current of claim 1, wherein each of the first AC LED group and the second AC LED group includes a plurality of AC LED blocks connected in series.

3. The AC LED device for eliminating harmonic current of claim 2, wherein each of the AC LEDs has a forward on voltage such that each of the first AC LED group and the second AC LED group has the overall forward on voltage, and wherein the resistor has a resistance configured to make the voltage across the first AC LED group and the second AC LED group higher than the overall forward on voltage.

4. The AC LED device for eliminating harmonic current of claim 2, wherein each AC LED block of the first AC LED group and the second AC LED group is composed of a plurality of LED micro-chips.

5. The AC LED device for eliminating harmonic current of claim 2, wherein each of the first AC LED group and the second AC LED group further comprises a chip in which the LED micro chips are integrated.
